(19) United States
(12) Patent Application Publication
(10) Pub. No.: US 2011/0197505 A1
(43) Pub. Date: Aug. 18, 2011

(54) INDOOR PLANT HARVESTING SYSTEM

(76) Inventor: Colt Jamison Hansen, La Pine, OR (US)

(21) Appl. No.: 12/658,992

(22) Filed: Feb. 17, 2010

(51) Int. Cl. A01G 9/12; A01G 9/02

(52) U.S. Cl. 47/65.8; 47/46

(57) ABSTRACT

An improved plant harvesting system of aerating pots, aerating pot supports and multi-tiered horizontal trellis plates that are spatially configured for maximum growth in a two month harvesting schedule of annual dioecious flowering herbs. This system is optimized to allow sufficient air to the plant roots, enhanced drainage of water from the potting media and to allow sufficient light to reach heavily shaded areas so as to spur on new shoot growth.

### BACKGROUND OF THE INVENTION

The present invention relates to a extremely compact system adapted to provide an optimal growing environment for harvested plants, primarily fast growing flowering vegetable plants, but not limited to these specific types. More particularly, to an improved plant growth system that minimizes rot and salt buildup on the plant's roots as well as maximizing the amount of air that circulates about the plant's roots.

When commercially harvesting a plant or the fruit thereof, the prominent concern (aside from the quality) is to be able get the most volume grown to maturity in the shortest time, using the least amount of space as possible. There are several ways to do this including hydroponics and bubbleponics coupled with a regimen of supplemental nutrients, light and water. Studies have shown however, that great advances in growth may be achieved buy using a modified environment for the plant that allows enhanced oxygenation and water drainage to the root system without the loss of potting media. Additionally, proper positioning of the plant with respect to the light also can dramatically increase the number of new shoots and thus the volume of material to be harvested.

Conventional pots do not allow sufficient air to the plant roots, nor do they drain water from the potting media fast enough or without slowly eroding the media. Conventional trellis configurations do not allow sufficient light to reach heavily shaded areas so as to spur on new shoot growth.

Henceforth, an improved indoor plant harvesting system would fulfill a long felt need in the horticultural industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide an improved plat harvesting system that is able to minimize plant spoilage and maximize the harvestable yield in the shortest period of time, and by making the most efficient use of space as possible. The advantages mentioned heretofore and many novel features that result in a new plant harvesting system which is not anticipated, rendered obvious, suggested, or even implied by any of the prior art, either alone or in any combination thereof.

In accordance with the invention, an object of the present invention is to provide an improved plant harvesting system capable of quickly draining excess water and nutrients from the root ball of a plant therein preventing root deterioration and salt buildup.

It is another object of this invention to provide an improved plant harvesting system compatible with conventional, hydroponic or bubbleponic plant growth systems and utilizing rectangular potting configurations.

It is a further object of this invention to provide an improved plant harvesting system capable of quickly draining the root ball without loss of potting media.

It is still a further object of this invention to provide for an improved plant harvesting system that maximizes the plant growth by redirecting the plant's direction of growth.

It is yet a further object of this invention to provide an improved plant harvesting system that allows maximum air and oxygen circulation about the plant's roots.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a perspective side view of the support and drainage tray with a tri level horizontal trellis tray configuration;

FIG. 2 is a perspective side view of the improved plant harvesting system showing the general arrangement of all components;

FIG. 3 is a perspective side view of a square aeration frame; and

FIG. 4 is a perspective side view of a rectangular aeration frame;

FIG. 5 is a perspective side view of a square soft pot with an upper cuff formed;

FIG. 6 is a perspective side view of a square soft pot in it's unrolled configuration;

FIG. 7 is a perspective side view of a rectangular soft pot with an upper cuff formed;

FIG. 8 is a perspective side view of a rectangular soft pot in it's unrolled configuration;

FIG. 9 is a perspective side view of a square aeration frame with a square soft pot installed;

FIG. 10 is a perspective side view of a rectangular aeration frame with a rectangular soft pot installed;

FIG. 11 is a perspective side view of a bi level horizontal trellis tray configuration for a conventional potted plant; and

FIG. 12 is a perspective side view of a bi level horizontal trellis tray configuration with a conventional potted plant drip dish inserted.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

It is to be noted that the improved plant harvesting system accomplishes its objective of maximizing growth of flowering vegetables and herbs in the shortest possible time and utilizing the minimal amount of space through the synergistic effects the system components. Experimental results have shown the combined effects of this system can triple the two month yield of annual dioecious flowering herbs harvested under conventional growing systems and reduce the amount of nutrients necessary by 20%.

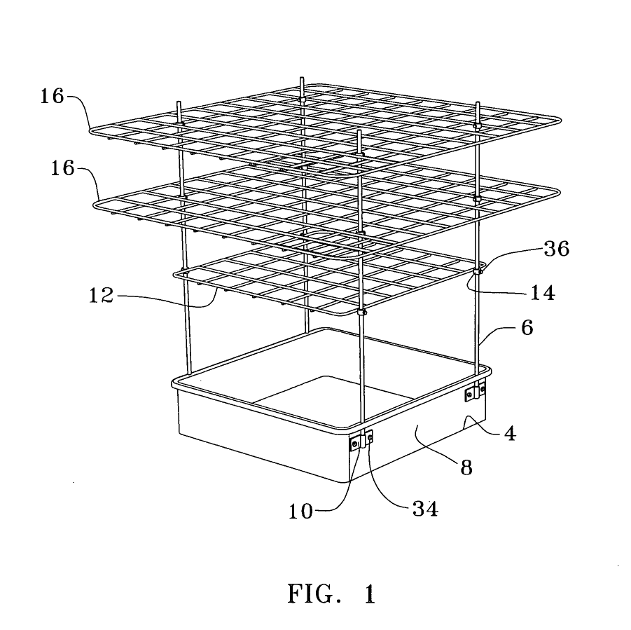

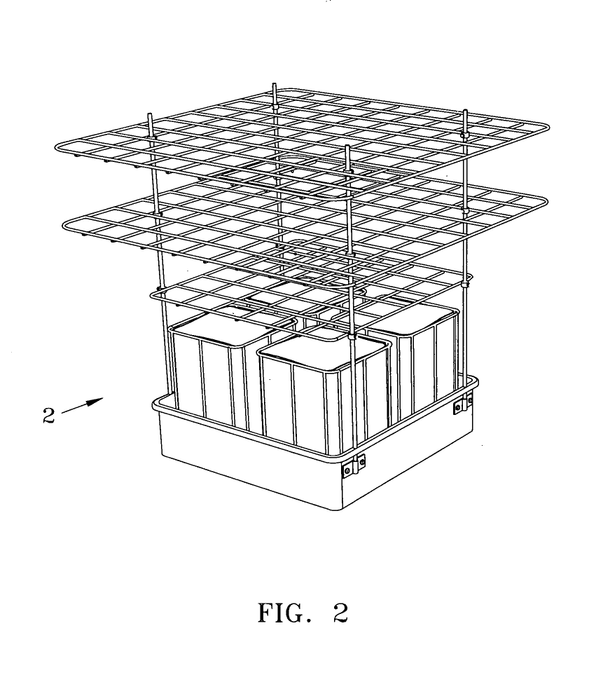

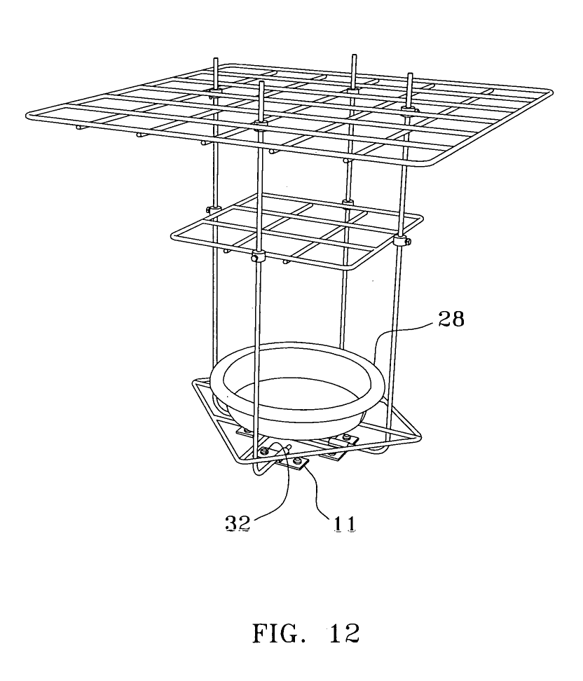

Looking at FIGS. 1, 3 and 5 the individual components of the complete system 2 as depicted in FIG. 2 can best be seen. A waterproof support and drainage collection tray 4 has four trellis tray support rods 6 mechanically fastened to the exterior side walls 8 by fasteners 10. The tray 4 has a generally planar bottom that extends upward into four conjoined side walls. A first horizontal trellis plate 12 having a square (or rectangular) grid formed thereon has four adjustable lock collars 14 affixed to the grid 12 (generally by welding) and adapted for sliding and locking engagement along the linear axis of the trellis tray support rods 6. Each of four lock collars 14 are firmly engaged onto the four trellis tray support rods 6 so as to hold the first horizontal trellis plate 12 in a horizontal plane parallel to the plane of the support and drainage collection tray 4. In a similar fashion a pair of larger, second horizontal trellis plates 16 are affixed to the trellis tray support rods 6 so as to form a stacked, spaced arrangement of horizontal trellis plates. Although depicted in a tri level array as in FIG. 2 and a bi level array as in FIG. 11 it is understood that any number of trellis plates may be utilized depending upon the size of the plant.

The system is completed by the insertion of several square (or rectangular) fabric “soft” pots 18 into square aeration frames 20 (or rectangular aeration frames 22) which are then positioned into the support and drainage collection tray 4 with a minimum of space (approximately 1 inch) between all sides of the square aeration frames 20 and the other square aeration frames 20 and the tray side walls 8. The aeration frames 20 and 22, trellis tray support rods 6, horizontal trellis plates 12 and 16, adjustable lock collars 14 and fasteners 10 are made of steel that is painted or powder coated gloss white to minimize corrosion and maximize light reflection although an unpainted stainless steel or a polymer would be acceptable material substitutes.

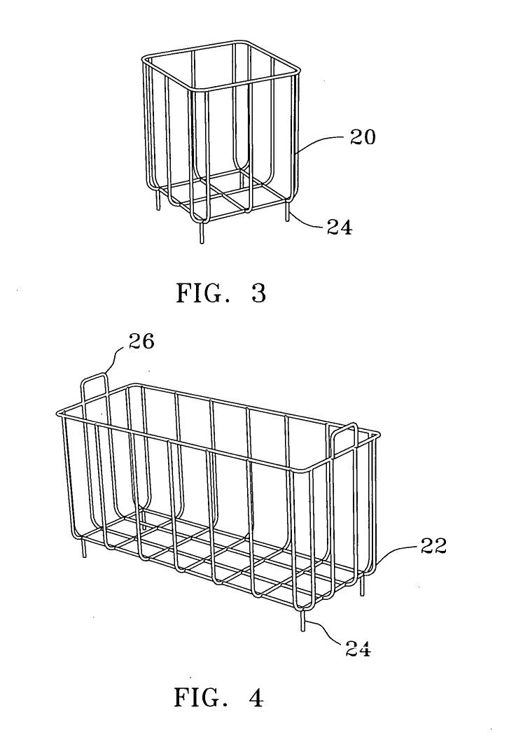

Looking at FIGS. 3 and 4 it can be seen that the aeration frames 20 and 22 are formed into generally cuboid structures (as are the mating soft pots) and have support legs 24 approximately one inch in height to keep the bottom of the frames and thus the bottom of the soft pots 18 out of any of the liquids collected in the support and drainage collection tray 4. Operationally, there should never be less than approximately one half inch of air space beneath each soft pot 18. There are optional handles 26 formed in the wire grid configuration of the larger aeration frames. The wire grid of the aeration frames 20 and 22, the trellis tray support rods 6 and the trellis plates 12 and 14 in the preferred embodiment use 3/16 inch cold rolled steel which is optimized for light shadowing.

In the preferred embodiment the support and drainage collection tray 4 is of a waterproof polymer with thick enough sides 8 to support a set of attachment rivets 34 (or alternately nuts, bolts and washers) to rigidly affix fasteners 10 which are welded to the bottom ends of the trellis tray support rods 6.

The four adjustable lock collars 14 are simply plain bushings with threaded through bores housing set screws 36 (or alternately thumb screws) therein. Screwing in the set screws 36 frictionally affixes the trellis plates 12 and 14 to the trellis tray support rods 6. Such lock collars are generally well known in numerous mechanical industries.

It is to be noted that this system is designed for use in an indoor, maximum harvesting environment with grow lights, hydroponics, heat and extreme nutrition. The trellis plates 12 and 14 are all configured as square with a coarse square mesh thereon. Each plate is generally planar wire rack having an internal grid formed by a series of square internal wire enclosures. This mesh is sized specifically so that the first trellis plate 12 retards a sufficient amount of the vertically upshooting plant growth (IE all those leaves under a certain size) and directs these leaves in a horizontal direction. The remainder of the vertical upshoots being smaller in size, are able to pass through the grids and continue on with their upward growth until the second trellis plate 14 is reached. In this way the system's trellis configuration and spacing eliminate the vertical collapse of plants that would grow upward too quickly and also spreads out the growth sideways fosterling new growth shoots upward from the horizontal stems. This makes a bushier plant with increased bud and fruit growth from the length of the entire stem rather than predominantly the top stem portion. Thus the plant is not prone to developing into a top heavy plant that is subject to stem collapse as the trellis plates help support much of the fruit and bud and constrains the vertical movement of the smaller growth shoots that pass through the trellis plates. This eliminates having to tie the plants to stakes for support.

In the preferred embodiment, the standard configuration for these trellis plates determined experimentally (for an 8 week harvest of annual dioecious flowering herbs) is as follows: the interior square grid spacing is best as a three×three inch or four×four inch configuration (or anywhere in between) with the first trellis plate sized overall at 12 inches square when the first trellis plate 12 is positioned 8-12 inches from the top of a 10 inch deep bed of soil in a soft pot 18; the second trellis plate 14 has the same internal square grid spacing but is sized approximately 4 times larger overall at 24 inches square and is positioned 8 inches from the first trellis plate 12; and subsequent second trellis plates 14 may be utilized at 8 inch spacings above adjacent plates.

Although all figures show all trellis plates aligned, it has been shown that rotating the adjacent trellis plates by 45 degrees with respect to each other will serve to further minimize vertical growth migration.

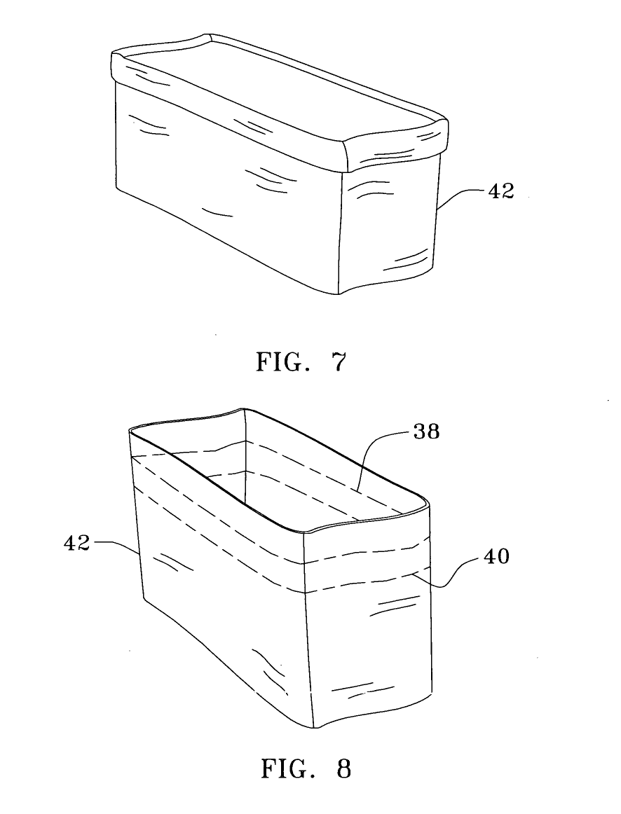

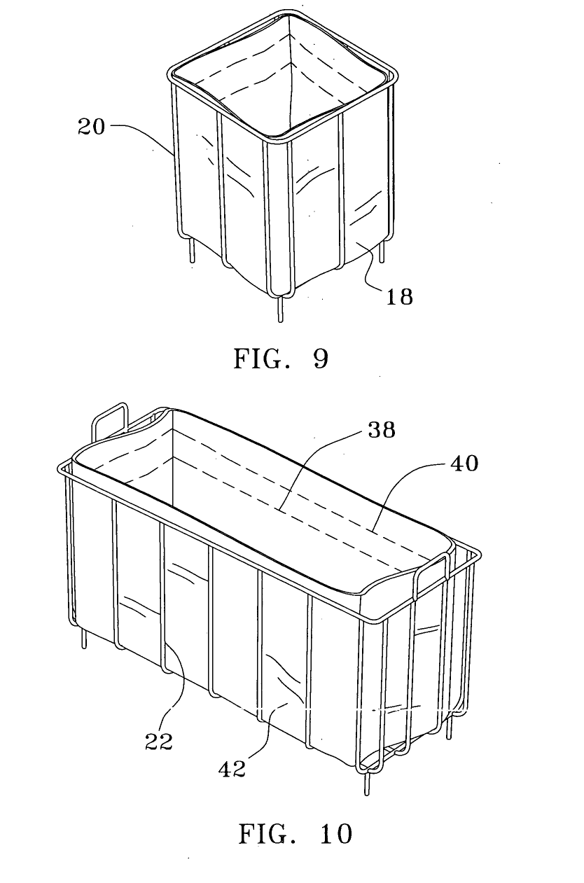

FIG. 6 shows the square pot 18 in the unrolled configuration. The pot is made square or as in FIGS. 7 and 8 conformed into a rectangular soft pot 42 but dimensioned in square multiples as are the matingly conformed square and rectangular aeration frames 20 and 22, so as to maximize the use of space. The soft pots are made of a non-woven polypropylene continuous fiber so as to form an approximately seven ounce in weight fabric that has been needle or pin punched to allow air infiltration and water drainage, and then subsequently heated to cause partial fusing of the fibers to strengthen the fabric. The weave of the fabric and the pin punches thereon are sized so as to constrain all of the potting media as the water/nutrient fluid drains. In this way in a hydroponic or bubbleponic system, the liquid drained into the tray can be recycled and pumped back into the soft pot on a timed basis. There are other suitable uniform, porous needle punched fabrics formed of continuous synthetic fibers such as polyolefin, polyester and polyamide (or any combination thereof.) This type of fabric is commonly used as the underlayment for the rubber liners in ponds.

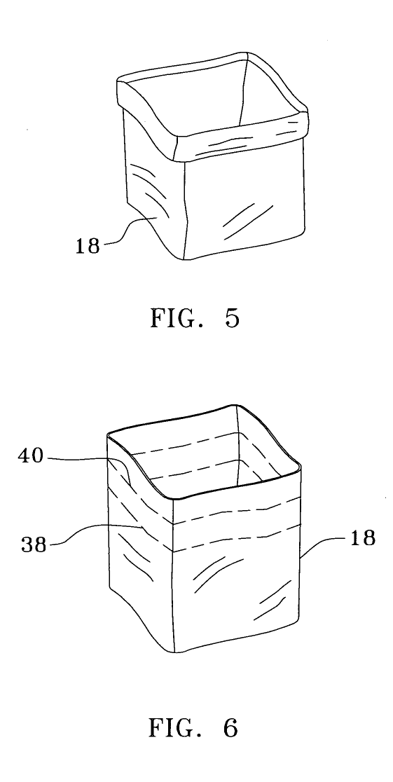

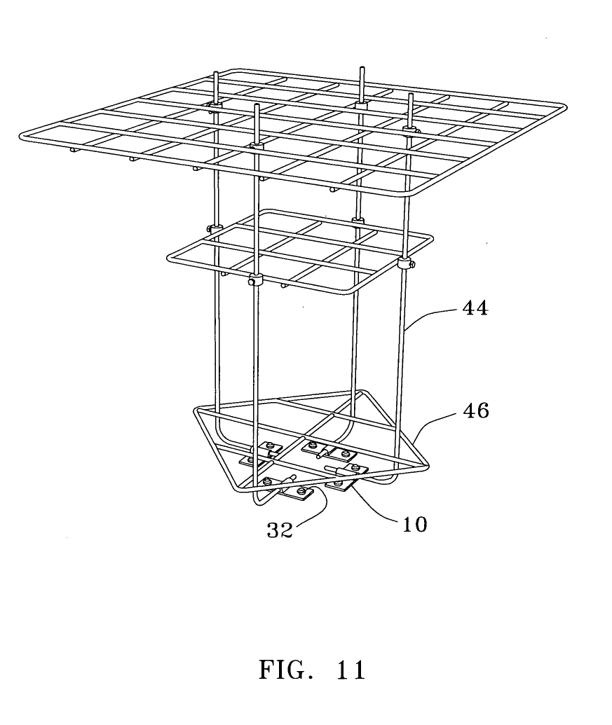

About the outer surfaces of the soft pots are a minimum potting media fill line 38 and a maximum potting media fill line 40 that is stitched with a color contrasting thread. In the preferred embodiment the square soft pot is eight inches wide, eight inches deep and 12 inches high uncuffed. In this size, filling between the minimum and maximum potting media fill lines of a square soft pot 18 will take approximately 1 gallon of potting media. This amount of potting media to be used in each of the soft pots has been experimentally determined to be the optimal amount for maximum growth with the trellis plate spacings discussed above. Looking at FIG. 5 the square soft pot 18 can be seen in the partially rolled configuration wherein the top exposed edges have been rolled back on themselves to make a fold within the minimum and maximum potting media fill lines, therein setting the potting media level for the owner. FIG. 9 shows the square soft pot 18 installed in the square aeration frame 20 while FIG. 10 shows the rectangular soft pot 42 installed in the rectangular aeration frame 22.

In an alternate embodiment (not illustrated) the physical configuration of the pot may be round rather than square. In such an embodiment the pot has a bottom, one contiguous side wall and two parallel line markings that reside about said side wall. Here, again these markings are minimum and maximum potting media fill lines stitched about the periphery of the pot to indicate the optimal amount of potting media to be utilized with that specific round pot. The round pot is sized such that when the top edge is rolled down to the maximum potting media fill line, approximately 1 gallon of potting media would be constrained within the round pot.

FIGS. 11 and 12 show an alternate embodiment improved plant harvesting system for a single plant with only two, smaller horizontal trellis plates. It does not use a drainage tray but rather a drainage dish 28 (or alternately a bucket) and could have a conventional pot or a trellis support frame with a soft pot set inside. The support frame is made of four support rods 44 bent below and welded to a base 46 at various points of intersection. The sections of support rods 44 below the base are affixed to fasteners plates 11. Here the fastener plates 11 are adapted for engagement (preferably by screws 32) to a planar substrate to prevent knocking over of the alternate embodiment system.

It is to be realized that the improved plant harvesting system as shown in FIG. 2 is a synergistic system wherein the use of all the components combined will yield the best results, but that significant harvesting improvements may be achieved using individual components.

In use, the top of the soft pot is rolled into a cuff that resides within the stitched min and max potting media markings. The soft pot is filled to the cuff with a potting media of a 70% soil component with 30% silica that is pH adjusted between 6.3 and 6.8 and the plant appropriately bedded. The soil component includes worm castings, soil, perlite, bat guano, fish, corn meal, forest humus, sandy loam and sphagum peat moss. The soft pot is placed into an aeration frame and placed adjacent similarly set up aeration frames in a drainage and collection tray with a minimum of about one inch of clearance around all sides of each aeration frame. The trellis plate support rods are inserted into the lock collars and the first horizontal trellis plate is adjusted until the plate resides approximately 8 to 12 inches above the top of the potting media. Similarly, the second horizontal trellis plate is positioned 8 inches above the first horizontal trellis plate and optionally, another second trellis plate is positioned 8 inches above that. The plant is watered with a water and nutrient solution and exposed to stimulating light as per the growers personal preferences. This may necessitate the use of a hydroponic or bubble hydroponic system with grow lights that circulate the nutrient rich water back into the soft pots on a timed basis. The water solution is able to almost completely drain through the soft pot into the drainage and collection tray below. The amount of water solution in the collection and drainage tray never reaches within one half inch of the bottom of the soft pot. The plant's roots are continually fed the water solution and then quickly drained by gravity to allow air drying from the air that is circulating under the bottom of the soft pot and passing up into the plant root ball. All the soil and plant roots remain in contact with an abundance of oxygen which greatly enhances the growing process and eliminates root rot and mildew development on the roots. This increase in aeration to the roots enhances the nutrient intake by minimizing the salt buildup on the roots. When the plant growth reaches the underside of the first horizontal trellis plate approximately 50% of the plant stems are directed sideways and 50% of the plant stems are guided through the grid openings in the first horizontal trellis plate. This spreading of growth allows more light to reach all of the plant parts which in turn initiates new upward growth from the sideways plant stems and limits the leaves between the horizontal trellis plates. The fruit and buds may rest on the trellis plates. When the new growth reaches subsequent higher trellis plates the process is repeated. The overall effect is a healthy, vibrant, and bushy plant with a stronger, healthier root system that does not undergo any collapsed stems, uses approximately 20% less nutrients, and yields a harvest approximately three times greater than that of a conventionally grown plant.

It is to be noted that the number of annual dioecious flowering herbs that a grower generally can have in their possession at any time is relatively small because of the extreme costs related to the nutrients as well as other restrictions. It is crucial that they are able to repeatedly obtain a high yield with a minimum of spoilage and in a small physical area. The invention described above enables just that.

The above description will enable any person skilled in the art to make and use this invention. It also sets forth the best modes for carrying out this invention. Although the abovementioned plant harvesting system was designed for and is directed towards the improved harvesting of annual dioecious flowering herbs, all plat growth may benefit from it. As such, there are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. An improved plant harvesting system comprising:
a waterproof tray having a generally planar bottom with contiguous conjoined tray walls extending normally from all sides of said bottom;
at least four linear trellis support rods affixed to said tray walls so as to extend vertically therefrom;
at least one horizontal trellis plate adjustably affixed to all of said trellis support rods;
at least one aeration frame having at least four legs extending therefrom; and
a porous fabric pot residing within an interior space defined by said aeration support frame;
wherein said porous fabric pots and said aeration frames are configured to have a generally cuboid shape, and said aeration frame resides on said tray bottom bounded by said tray walls.

2. The improved plant harvesting system of claim 1 further comprising a fastener that is joined to a bottom end of said linear trellis support rods and is mechanically affixed to said tray side.

3. The improved plant harvesting system of claim 2 wherein said trellis plate is a generally planar wire rack having an internal grid formed by a series of square internal wire enclosures.

4. The improved plant harvesting system of claim 3 wherein said porous fabric pot is made of a needle punched, non-woven continuous synthetic polymer fiber selected from the group of polymer fibers including polypropylene, polyolefin, polyester, polyamide or any combination thereof.

5. The improved plant harvesting system of claim 4 wherein said fabric pot has a bottom, four side walls and two parallel line markings that reside about said side walls.

6. The improved plant harvesting system of claim 5 wherein said each trellis plate has four lock collars affixed thereto and wherein said lock collars are matingly conformed to said trellis support rods for sliding engagement.

7. The improved plant harvesting system of claim 6 wherein said lock collars are plain bushings with set screws threadingly engaged with threaded orifices formed there through said bushing.

8. The improved plant harvesting system of claim 7 wherein said aeration frame, said trellis plate, said trellis support rods and said lock collars are surface coated with a gloss white paint.

9. The improved plant harvesting system of claim 8 wherein said aeration frame, said trellis plate and said trellis support rods are made of 3/16 inch thick cold rolled steel.

10. The improved plant harvesting system of claim 8 wherein the number of trellis plates is three.

11. An improved plant harvesting system comprising:
a generally planar bottom plate;
at least four linear trellis support rods affixed to said bottom plate, each having a curved lower end extending below said bottom plate;
at least one horizontal trellis plate adjustably affixed to all of said trellis support rods; and
at least four fastener plates rigidly affixed to said trellis support rod's curved lower end wherein each fastener plate has at least one orifice formed therethrough for accepting a fastener.

12. The improved plant harvesting system further comprising:
an aeration frame having at least four legs extending therefrom; and
a porous fabric pot residing within an interior space defined by said aeration support frame;
wherein said porous fabric pot and said aeration frame are configured to have a generally cuboid shape, and said aeration frame resides on said bottom plate.

13. The improved plant harvesting system of claim 12 wherein said aeration frame, said trellis plate, said trellis support rods, said bottom plate and said lock collars are surface coated with a gloss white paint.

14. The improved plant harvesting system of claim 13 wherein said aeration frame, said trellis plate, said bottom plate and said trellis support rods are made of 3/16 inch thick cold rolled steel.

15. The improved plant harvesting system of claim 14 wherein the number of trellis plates is two.

16. The improved plant harvesting system of claim 14 wherein the number of trellis plates is three.

17. The improved plant harvesting system of claim 4 wherein said fabric pot has a round configuration with a bottom, and one contiguous side wall and two parallel line markings that reside about said side wall.
